(19) United States
(12) Patent Application Publication
(10) Pub. No.: US 2018/0132014 A1
(43) Pub. Date: May 10, 2018

(54) CROWD-SOURCED VIDEO GENERATION

(71) Applicant: PLAYSIGHT INTERACTIVE LTD., Kfar Saba (IL)

(72) Inventors: Evgeni KHAZANOV, Petah Tiqva (IL); Chen SHACHAR, Kohav Yair (IL)

(73) Assignee: PLAYSIGHT INTERACTIVE LTD., Kfar Saba (IL)

(21) Appl. No.: 15/573,121

(22) PCT Filed: May 22, 2015
(86) PCT No.: PCT/IB15/53801

§ 371 Date: Nov. 9, 2017

(51) Int. Cl. H04N 21/8549; G11B 27/031; H04N 21/218; H04N 21/2743; H04N 21/4223; H04N 21/472; H04N 21/231; H04N 21/84

(52) U.S. Cl. CPC H04N 21/8549; G11B 27/031; H04N 21/21805; H04N 21/84; H04N 21/4223; H04N 21/47205; H04N 21/231; H04N 21/2743

(57) ABSTRACT

A computer implemented method of crowd-sourced video generation, comprising: by a server computer in communication with a plurality of remote client devices, receiving a feed of video captured by a camera, on a memory of the server computer, storing at least a portion of the video feed being received, receiving at least one tag from a respective one of the client devices, determining an occurrence of an event type, based on an at least one of the received tags, and forwarding a sub-portion of the video feed portion stored on the memory for further processing, the forwarded sub-portion having a video length predefined for the event type of the determined occurrence.

### FIELD AND BACKGROUND OF THE INVENTION

The present invention relates to video capture, generation and editing, and more particularly, but not exclusively to a system and method for crowd-sourced video generation.

Today, millions of events such as public performances, tennis games, football games, lectures, speeches, etc., are attended by sport fans, students, and other audiences. Such events are very often broadcast on TV Channels or over the internet, and watched at home by audiences from their homes, from remote university classes, etc., as known in the art.

During the watching of such an event, an attendee physically present at such an event, may capture still images and video sequences of the event using a camera installed on a device (say a smart phone or a tablet computer) in use by the attendee, as known in the art.

Similarly, any member of an audience, who watches the event on TV or on the internet, may choose to capture still images or video of the event, by a smart phone's camera aimed at a TV or a computer screen, by recording, etc.

The member may forward the images or video to a friend, a family member, or a colleague, say by email. In that way, the member may share occurrences of interest caught in the images with friends, family, colleagues, etc.

The member may also upload the still images or video to one of the many popular public Social Networking websites—such as YouTube, thus sharing the moments of interest with friends, family, colleagues, or a more general public.

### SUMMARY OF THE INVENTION

According to one aspect of the present invention there is provided a computer implemented method of crowd-sourced video generation, comprising: by a server computer in communication with a plurality of remote client devices, receiving a feed of video captured by a camera, on a memory of the server computer, storing at least a portion of the video feed being received, receiving at least one tag from a respective one of the client devices, determining an occurrence of an event type, based on an at least one of the received tags, and forwarding a sub-portion of the video feed portion stored on the memory for further processing, the forwarded sub-portion having a video length predefined for the event type of the determined occurrence.

According to a second aspect of the present invention there is provided a non-transitory computer readable medium storing computer executable instructions for performing steps of crowd-sourced video generation, the steps comprising: by a server computer in communication with a plurality of remote client devices, receiving a feed of video captured by a camera, on a memory of the server computer, storing at least a portion of the video feed being received, receiving at least one tag from a respective one of the client devices, determining an occurrence of an event type, based on an at least one of the received tags, and forwarding a sub-portion of the video feed portion stored on the memory for further processing, the forwarded sub-portion having a video length predefined for the event type of the determined occurrence.

According to a third aspect of the present invention there is provided an apparatus for crowd-sourced video generation, implemented on at least one server computer in communication with a plurality of remote client devices, and comprising: a video feed receiver, configured to receive a feed of video captured by a camera, a memory maintainer, in communication with the video feed receiver, configured to store at least a portion of the video feed being received, on a memory of the server computer, a tag receiver, configured to receive at least one tag from a respective one of the client devices, an occurrence determiner, in communication with the tag receiver, configured to determine an occurrence of an event type, based on an at least one of the received tags, and a forwarder, in communication with the occurrence determiner and the memory maintainer, configured to forwarding a sub-portion of the video feed portion stored in the memory for further processing, the forwarded sub-portion having a video length predefined for the event type of the determined occurrence.

Unless otherwise defined, all technical and scientific terms used herein have the same meaning as commonly understood by one of ordinary skill in the art to which this invention belongs. The materials, methods, and examples provided herein are illustrative only and not intended to be limiting.

Implementation of the method and system of the present invention involves performing or completing certain selected tasks or steps manually, automatically, or a combination thereof.

Moreover, according to actual instrumentation and equipment of preferred embodiments of the method and system of the present invention, several selected steps could be implemented by hardware or by software on any operating system of any firmware or a combination thereof.

For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. The description taken with the drawings making apparent to those skilled in the art how the several forms of the invention may be embodied in practice.

In the drawings:

FIG. 1 is a block diagram schematically illustrating a first exemplary apparatus for crowd-sourced video generation, according to an exemplary embodiment of the present invention.

FIG. 2 is a simplified flowchart schematically illustrating an exemplary method for crowd-sourced video generation, according to an exemplary embodiment of the present invention.

FIG. 3, is a block diagram schematically illustrating a first exemplary GUI for crowd-sourced video generation, according to an exemplary embodiment of the present invention.

FIG. 4 is a block diagram schematically illustrating a second exemplary GUI for crowd-sourced video generation, according to an exemplary embodiment of the present invention.

FIG. 5 is a block diagram schematically illustrating computer memory buffer usage in performing steps of crowd-sourced video generation, according to an exemplary embodiment of the present invention.

FIG. 6 is a block diagram schematically illustrating an exemplary computer readable medium storing computer executable instructions for performing steps of crowd-sourced video generation, according to an exemplary embodiment of the present invention.

FIG. 7A is a block diagram schematically illustrating a first exemplary implementation scenario of crowd-sourced video generation, according to an exemplary embodiment of the present invention.

FIG. 7B is a block diagram schematically illustrating a second exemplary implementation scenario of crowd-sourced video generation, according to an exemplary embodiment of the present invention.

### DESCRIPTION OF THE PREFERRED EMBODIMENTS

The present embodiments comprise an apparatus and a method for crowd-sourced video generation.

Today, millions of events such as public performances, tennis games, football games, lectures, political speeches, etc., are attended by sport fans, students, political party members, and other audiences. Such events are very often broadcast on TV Channels or over the internet, and watched at home by audiences from their homes, from remote university classes, etc., as known in the art.

During the watching of an event such as a soccer game between two college teams, an attendee may wish to capture a certain occurrence of an event type of interest to the attendee. The occurrence may be of a more personal interest (say a kicking of a ball by the attendee's son who plays in one of the teams), of a more public interest (say a scoring of a goal, an out event, etc.).

The attendee may try to capture the occurrence with his smart phone's camera, or with another client device. However, very often, the attendee fails to achieve satisfactory results because of a variety of reasons such as the attendee's delayed response to the occurrence, a low quality of the smart phone's camera, etc., as known in the art.

A member of a TV Audience, who watches the game on TV, is often even less likely to be able capture the occurrence of interest during a broadcast of the soccer game on TV, particularly when the member does not record the broadcast.

According to an exemplary embodiment of the present invention, a server computer is in communication with a plurality of remote client devices in use by members of the audience—be the members attendees of a sport game or a concert, members of a an audience who watch the game or concert live on TV, etc.

The server computer may identify the remote client devices as belonging to an audience of a same concert, football game, etc., say using GPS (Global Positioning System) data, as described in further detail hereinbelow.

On the server computer, there is received a feed of video captured by one or more cameras—say by a professional video camera in use by a Television (TV) crew around a soccer field during a live broadcast of a soccer game on a TV Channel operated by the owner of the server computer, say by a TV Corporation.

At least a portion of the video feed being received is stored on memory of the server computer.

In a first example, when one member of an audience who watches the game from a seat in a stadium in which the game takes place, sees that the member's son who plays in one of the rival teams receives the ball, the member pushes a specific one of a few buttons in a GUI (Graphical User Interface) presented on the member's smart phone.

Consequently, a tag which contains the text of ‘my boy has the ball’ or another event type indication (say a code predefined by a user or programmer of a program implementing the GUI on a website accessed by the member's smart phone) is sent to the server computer, as described in further detail hereinbelow.

Upon receipt of the tag from the member, the server computer determines an occurrence of a predefined event type, based on the received tag. The event type of the example is the ‘my boy has the ball’ event.

Then, the server computer forwards a sub-portion of the video feed portion stored on the server computer's memory for further processing, the forwarded sub-portion has a video length predefined for the event type of the determined occurrence—i.e. to ‘my boy has the ball’ events, say a length of two minutes.

In the example, the sub-portion spans over a time period of two minutes preceding the time of receipt of the tag. Consequently, there may be increased the chance of catching the event of the member's boy having the ball in the sub-portion, when taking into consideration the time it takes for the member to send the tag, say by pushing the right GUI radio button, as described in further detail hereinbelow.

In the example, the further processing involves generating a two minutes long video clip which is based on the forwarded sub-portion of the video, and which includes titles which give the game, date, and competing teams, as well as a ‘my boy has the ball’ title.

Then, a link usable for downloading the video clip is sent to the member's smart phone, say in an SMS (Short Message Service) or email message, and the member may forward the email to his family and friends. Optionally, the member is sent the link shortly after the event occurs (say a minute or two after the member's son receives the ball).

Alternatively or additionally, the video clip may be distributed to one or more recipients directly, from the server computer, using a recipients list predefined say by the member, through remote access to the server computer, say on a website implemented on the remote computer.

In a second example, the server computer realizes that the client devices are used by audience members who attend a same concert, game, etc., using GPS (Global Positioning System) or other location data included in tags received from the client devices when the game or concert is played.

In the second example, each one of the tags received from the client devices, includes an event type, a time stamp marking the time in which the tag is generated, and GPS data which reveals the location of the client device which sends the tag to the server computer when the client device sends the tag.

In the second example, tags which bear GPS data which indicates a location within a same sport stadium and which according to their time stamps, are sent during a time period in which the video feed of a specific sport event (say a specific soccer game played in the stadium) is received. Consequently, the tags are taken into consideration for determining event types' occurrences during the specific sport event (say soccer game).

When several hundreds of the tags taken into consideration bear a ‘Fault’ event type indication, and are received within a period of one minute, the server computer determines a ‘Fault’ event occurrence.

Consequently, the server computer forwards a one minute (going from the time of receipt of a median one of the tags backwards) long sub-portion of the video portion stored on the memory of the server computer to a computer used for video clip distribution.

On the computer used for video clip distribution, the sub-portion is used to generate a one minute long video clip which is based on the forwarded sub-portion of the video, and which includes titles which give the game, date, rival teams, and a ‘Fault’ title.

Then or later, the one minute long video clip which bears the ‘Fault’ title is sent to all client devices which according to the GPS data, are simultaneously present at the sport stadium during the game.

However, when only a small number of the tags (say a few dozens) taken into consideration on basis of their concurrent presence within the stadium during the game, bear a ‘Fault’ event and are received within a period of one minute, the server computer rather determines the occurrence of a ‘Fault in question’ event type.

Consequently, the server computer still forwards a one minute long (going from the time of receipt of a median one of the tags backwards) sub-portion of the video portion stored on the memory of the server computer to the computer used for video clip distribution.

Further, on the computer used for video clip distribution, the sub-portion is still used to generate a one minute long video clip which is based on the forwarded sub-portion of the video, and which includes titles which give the game, date, and rival teams. However, the generated video clip bears a ‘Fault??’ title rather than the ‘Fault’ title.

Then, the computer used for video clip distribution sends the video clip bearing the ‘Fault??’ title, but only to the few dozens client devices from which the tags bearing the ‘Fault’ event of the one minute period originate.

Optionally, as the video feed captured by a camera is being received, there are maintained one or more buffers in which the received video feed's frames are stored, such that at least one of the buffers stores a most recent portion of the video feed being received, as described in further detail hereinbelow.

Consequently, upon determining of the event type occurrence, based on the tags received from the client devices, there is forwarded the sub-portion of the length predefined for the event type, say to the computer used for video clip distribution. Consequently and potentially, there may be saved bandwidth, memory space, etc., as described in further detail hereinbelow.

Thus, in one example, a first server computer is deployed on a facility (say a stadium) in which an event such as a game of soccer or tennis takes place.

In the example, the video of the event (say soccer game) is captured by a TV channel's camera deployed at the facility, and is also broadcast live on the TV Channel, while simultaneously being received by the first server computer.

The first server computer is in communication with client devices in use by an audience made of sport fans physically present in the facility and of sport fans who watch the live broadcast of the event on the TV Channel.

The first server computer's communication with the client devices may be a direct communication say over Wi-Fi connection, or rather a communication mediated by one or more other server computers, etc., as described in further detail hereinbelow.

The first server computer maintains a buffer in which the received video feed's most recent portion, say the feed's video frames received in the last ten minutes, are stored, as described in further detail hereinbelow.

When an occurrence of an event type such as Goal, a Fault, an Out, etc., is determined based on tags received from some of the client devices, the first server computer forwards a sub-portion of a video length predefined (say by a programmer or administrator of the first server computer) to a second server computer.

In the example, the second server computer is a server computer operated by the TV channel's team, for distributing video clips, promos, etc., on a website, in email messages, etc., to users who subscribe to the channel or sign up in the TV channel's webpage, as known in the art.

In the example, the second server receives the forwarded sub-portion, generates a video clip based on the sub-portion, and distributes the generated video clip to one or more of the client devices.

Optionally, the second server computer selects the recipients according to the specific event type of the determined occurrence, etc., as described in further detail hereinbelow.

In that way, an audience member may share specific moments of interest to the member—say a goal by a popular soccer player or by the member's son, as caught in high quality video captured by the TV Channel's camera or another camera in use in the facility in which the event (say game) takes place, with friends, family, etc.

Thus, potentially, with presented embodiments of the present invention, the sharing of high quality video clips of moments of interest with friends, family, etc., may be turned into a more spontaneous experience, with possibly, an immediate or an almost immediate forwarding of the moments of interest video to friends, family, etc.

The principles and operation of an apparatus, method, and medium according to the present invention may be better understood with reference to the drawings and accompanying description.

Before explaining at least one embodiment of the invention in detail, it is to be understood that the invention is not limited in its application to the details of construction and the arrangement of the components set forth in the following description or illustrated in the drawings.

The invention is capable of other embodiments or of being practiced or carried out in various ways. Also, it is to be understood that the phraseology and terminology employed herein is for the purpose of description and should not be regarded as limiting.

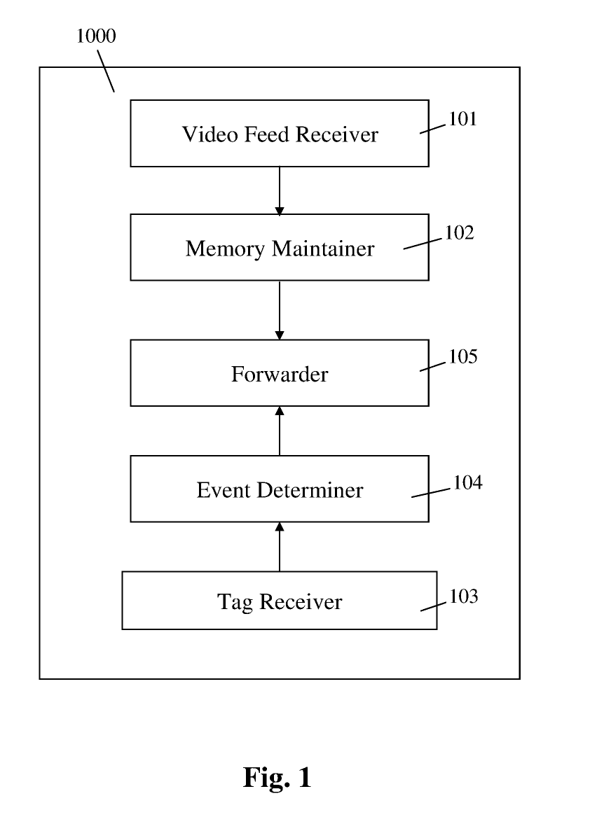

Reference is now made to FIG. 1, which is a block diagram schematically illustrating a first exemplary apparatus for crowd-sourced video generation, according to an exemplary embodiment of the present invention.

A first exemplary apparatus 1000 for crowd-sourced video generation, according to an exemplary embodiment of the present invention is implemented on a server computer. The server computer communicates with client devices such as a smart mobile phone, a tablet computer, a laptop computer, etc., as described in further detail hereinabove.

The apparatus 1000 includes the server computer's computer processor and one or more additional parts, such as the parts denoted 101-105 in FIG. 1.

The additional parts may be implemented as software, say by programming the computer processor to execute steps of the methods described in further detail hereinbelow.

In one example, the server computer is deployed at a facility such as a sport stadium in which a sport event such as a game of football or soccer takes place, at a lecture room, etc., as described in further detail hereinbelow.

In the example, the server computer communicates with one or more cameras in use at the facility (say in a sport stadium)—say with one or more professional TV cameras installed at the facility, over a wired or wireless local area network, as described in further detail hereinbelow.

Further in the example, the server computer also communicates with multiple client devices, say smart cellular phones or tablet computers, which are in use by users present at the stadium during the sport event, by users who watch the sport event on TV or over the internet, etc., or any combination thereof as described in further detail hereinbelow.

Thus, the exemplary first apparatus 1000 includes a video feed receiver 101 implemented on the server computer's computer processor.

During an event such as the sport event of the example, the video feed receiver 101 receives a feed of video captured by the camera, as described in further detail hereinbelow.

The apparatus 1000 further includes a memory maintainer 102 in communication with the video feed receiver 101.

During the receiving of the video feed by the video feed receiver 101, the memory maintainer 102 stores at least a portion of the video feed being received, on a memory of the server computer, as described in further detail hereinbelow.

For example, the memory maintainer 102 may maintain one or more buffers on the memory of the server computer, and store the at least a portion of the video feed in one or more of the buffers, as described in further detail hereinbelow.

Thus in one example, at least one of the buffers stores a most recent portion of the video feed being received by the video feed receiver 101, say the last ten minutes of video received by the video feed receiver 101, as described in further detail hereinbelow.

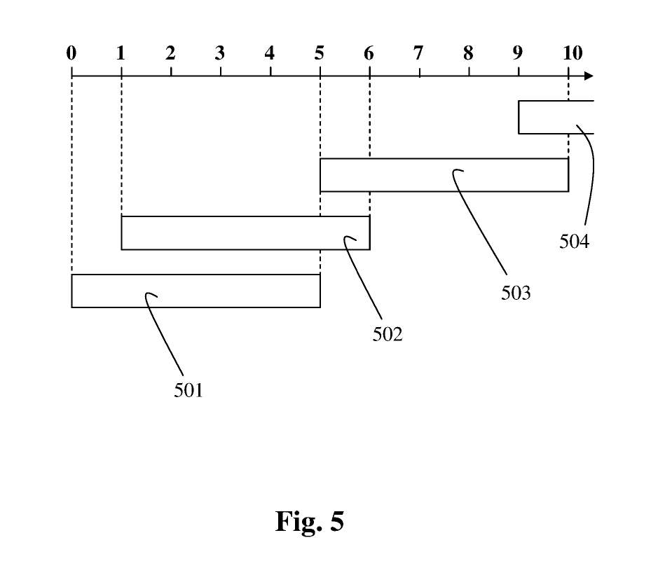

Optionally, throughout at least a part of the receiving of the video, the memory maintainer 102 concurrently maintains at least two buffers which span partially overlapping time frames, while dynamically discarding and opening buffers, as described in further detail hereinbelow, and as illustrated using FIG. 5.

The apparatus 1000 further includes a tag receiver 103.

During the event (say sport game), the tag receiver 103 receives one or more tags. Each one of the tags is received from a respective one of the client devices in communication with the server computer while the user of the client device watches the event (say game), say from a seat in the stadium or rather from home (say on a TV Channel or on a website).

Thus, in one example, when a user of a client device who watches the game, sees that the user's son who happens to play in one of the game's rival teams, catches the ball, the user sends a tag to the server computer, and the tag receiver 103 receives the tag.

Optionally, for generating and sending the tag, the user pushes a specific one of a few radio buttons presented in a GUI (Graphical User Interface) provided to the user on the user's client device (say the user's smart phone), as described in further detail hereinbelow.

Consequently, a tag which contains the text of ‘my boy has the ball’ or another event type indication (say a code predefined by a user or a programmer of a program which implements the GUI on the user's client device) is sent to the server computer, and is received by the tag receiver 103, as described in further detail hereinbelow.

The apparatus 1000 further includes an event determiner 104 in communication with the tag receiver 103.

The event determiner 104 determines 204 an occurrence of a predefined event type, based on one or more of the tags received by the tag receiver 103.

Optionally, the event determiner 104 bases the determining of the occurrence on an event type indication received in one or more of the tags.

Thus, in one example, the event determiner 104 may determine a ‘my boy has the ball’ event based on the tag of the above made example (i.e. the ‘my boy has the ball’ text or another event type indication included in the tag of the example).

Optionally, the event determiner 104 further bases the determining of the occurrence on a correlation which the event determiner 104 finds between an event type indication received in a first one of the tags and an event type indication received in a second one of the tags, as described in further detail hereinbelow.

Optionally, the event determiner 104 further bases the determining of the occurrence on a correlation which the event determiner 104 finds among event type indications received in several ones of the tags, as described in further detail hereinbelow.

Thus, in one example, when a tag which bears a ‘Goal’ text (which text thus serves as an indication of a Soccer Goal event type) is received by the tag receiver 103 from a single client device only, no Goal event is determined by the event determiner 104.

However, when tags bearing a ‘Goal’ text are received by the tag receiver 103 from several ones of the client devices, a Goal event is determined by the event determiner 104, provided that the tags are received 203 from client devices simultaneously present at the same facility, as described in further detail hereinbelow.

Optionally, at least one of the tags received by the tag receiver 103 bears a time indication, and the event determiner's 104 determining of the occurrence of the event type is further based on the time indication received in the tag. For example, the time indication may mark a time which is within a predefined time period of a soccer game as input in advance, say by an administrator of the apparatus 1000.

Optionally, the event determiner 104 further bases the determining of the occurrence on a correlation which the event determiner 104 finds between a time indication received in a first one of the tags and a time indication received in a second one of the tags.

Optionally, the event determiner 104 further bases the determining of the occurrence on a correlation which the event determiner 104 finds among time indications received in several ones of the tags, as described in further detail hereinbelow.

Optionally, the event determiner 104 further bases the determining of the occurrence on a time of receipt of one or more of the tags—say by giving less weight to tags received too shortly after an event of the same sort (say a goal) has already been determined, while giving more weight to tags which are received later.

Thus, in one example, the event determiner 104 discards tags bearing the text ‘Fault’ when the tags are received less than one minutes after the event determiner 104 determines a first Fault Event, but determines a second Fault Event based on tags received more than one minute after the event determiner 104 determines that first Fault event.

Optionally, the event determiner 104 further bases the determining of the occurrence on a correlation which the event determiner 104 finds between a time of receipt of a first one of the tags and a time of receipt of a second one of the tags, as described in further detail hereinbelow.

Optionally, the event determiner 104 further bases the determining of the occurrence on a correlation which the event determiner 104 finds among times of receipt of several ones of the received tags.

Thus, in one example, the determining of an occurrence of a Goal is made only if the number of tags indicating a Goal event, which tags are received within a period of one minute, exceeds a threshold predefined by a programmer or administrator.

In the example, in order to be taken into consideration for the determining 204, the location indication needs to mark a location which is within an area of a stadium in which a soccer game takes place, as input by an administrator of the server computer, as described in further detail hereinbelow. The location indication is verified as marking a location within the area of the stadium using a GPS Map, as known in the art.

Optionally, at least one of the tags received by the tag receiver 103 bears a location indication, and the event determiner's 104 determining of the occurrence of the event type is further based on the location indication received in the tag, as described in further detail hereinbelow.

Thus, in one example, in order to be taken into consideration for the determining 204, the location indication needs to mark a location which is within an area of a stadium in which a soccer game takes place, as input by an administrator of apparatus 1000, as described in further detail hereinbelow.

Optionally, the event determiner 104 further bases the determining of the occurrence on a correlation which the event determiner 104 finds between a location indication received in a first one of the tags and a location indication received in a second one of the tags, as described in further detail hereinbelow.

Optionally, the event determiner 104 further bases the determining of the occurrence on a correlation which the event determiner 104 finds among location indications received in several ones of the tags.

For example, for the determining 204, the event determiner 104 may give a higher weight to tags received from client devices which according to the location indications in the received tags, are positioned closer to one of the soccer gates.

With the exemplary apparatus 1000, each event type may is associated with a respective video length.

Thus, in a first example, the method further includes a preliminary step in which an administrator or a programmer of apparatus 1000 assigns a specific video length to each one of a group of event types predefined by the administrator or programmer.

Additionally or alternatively, the programmer or administrator may pre-define a default length which applies to all event types, such that unless being assigned with a video length specific to the event type, an event type is associated with that default predefined length.

The apparatus 1000 further includes a forwarder 105 in communication with the event determiner 104.

Based on the occurrence determined by the event determiner 104, the forwarder 105 forwards a sub-portion of the video feed portion stored on the memory for further processing, as described in further detail hereinbelow.

The video sub-portion forwarded by the forwarder 105 has a video length predefined for the event type of the determined occurrence, as described in further detail hereinbelow.

Optionally, the forwarder 105 forwards the sub-portion by communicating the sub-portion to a computer in remote communication with the server computer, say to a computer used for distributing video, as described in further detail hereinbelow.

Optionally, the further processing is rather carried by on the server computer itself—say by the video clip generator implemented on the server computer, as described in further detail hereinbelow.

Optionally, the forwarder 105 forwards the sub-portion from the buffer which stores a most recent portion of the video feed being received by the video feed receiver 101, as described in further detail hereinbelow.

In one example, the forwarded sub-portion has a video length of two minutes, as assigned by the administrator to the specific ‘my boy has the ball’ event type in the preliminary step, as described in further detail hereinabove.

In the example, the sub-portion spans over a two minutes long time period immediately before the tag's receipt by the tag receiver 103. Consequently, the event of the user's boy having the ball is more likely to be included in the forwarded sub-portion, in spite of a likely delay in the user's reacting to the event by pushing of the right GUI radio button, for sending the tag, as described in further detail hereinbelow.

In one example, the apparatus 1000 further includes a video clip generator (not shown).

Optionally, in the example, the video clip generator is implemented on the server computer.

Alternatively, the video clip generator is rather implemented on a computer in communication with the server computer—say on the computer used for distributing video, as described in further detail hereinbelow.

In the example, the further processing involves a generation of a two minutes long video clip by the video clip generator, and the video clip is based on the forwarded sub-portion. The video clip generated based on the forwarded sub-portion includes titles which give the game, game date, rival teams, etc., as well as a ‘my boy has the ball’ title, as described in further detail hereinbelow.

Optionally, in the example, the apparatus 1000 further includes a video distributer (not shown). The video distributer may be implemented on the server computer or rather on another computer, say on the computer used for distributing video, as described in further detail hereinbelow.

The video distributer distributes the video clip generated by the video clip generator, to one or more of the client devices in communication with the server computer.

Optionally, in the example, the video distributer distributes the video clip as a link usable for downloading the video clip, which link the video distributer sends to a specific user's smart phone from which the received tag that the determining of the event is based on originates, say in an SMS (Short Message Service) or email message. Consequently, the specific user may forward the link to his family, friends, etc., say within a short time, say a few minutes after the occurrence.

Alternatively or additionally, the video distributer distributes the video clip to one or more recipients directly, say over the internet and using a recipients list predefined by the specific smart phone's user through remote access to a website implemented on the remote computer or on the computer used for distributing video.

Optionally, the forwarder 105 forwards the sub-portion directly to one or more of the client devices (say over the internet). Then, a client application which runs on the client device processes the sub-portion (say by adapting the sub-potion for presentation on the client device), and presents the sub-portion on the client device's screen.

In one example, the event determiner 104 identifies at least some of the client devices as being used by audience members who concurrently attend a same event (say a soccer game), using GPS (Global Positioning System) data or other location data included in the tags received from the identified client devices, during the event.

In the example, each specific one of the tags includes an event type, a time stamp which marks the time in which the specific tag is generated, and GPS data which reveals the location of the client device which the specific tag originates from, when the client device sends the specific tag.

In the example, only tags which bear GPS data that indicates a location within a same stadium in which the event takes place, and time stamps that mark a time within a time period in which a video feed of the event (say the soccer game) is received, are taken into consideration for determining the event types' occurrences during the event.

When several hundreds of the tags which are taken into consideration bear a ‘Fault’ event type indication, and are received within a period of one minute (separating the earliest and latest ones of the tags bearing the ‘Fault’ event type indications), the event determiner 104 determines a ‘Fault’ event occurrence.

Consequently, the forwarder 205 forwards a one minute long sub-portion of the video portion (going from the time of receipt of a median one of the tags, in as far as the tags' order of receipt is concerned, backwards) stored on the memory of the server computer to the computer used for video clip distribution.

In the example, on the computer used for video clip distribution, the video clip generator uses the forwarded sub-portion to generate a one minute long video clip which is based on the forwarded sub-portion, and which includes titles which give the game, game date, rival teams, etc., as well as a ‘Fault’ title.

Then or later, the video distributer sends a copy of the one minute long video clip bearing the ‘Fault’ title to each one of the client devices which according to the location data (say GPS) included in the tag received from the client device, is present at the facility (say stadium) in which the event (say soccer game) takes place.

However, when only a small number of the tags (say a few dozens) taken into consideration on basis of their concurrent presence within the facility during the event (say soccer game) bear a ‘Fault’ event and are received within a period of one minute, the event determiner 104 rather determines a ‘Fault in question’ event type occurrence.

Consequently, in the example, the forwarder 105 still forwards a one minute long (going from the time of receipt of a median one of the tags backwards) sub-portion of the video portion stored on the memory of the server computer to the computer used for video clip distribution.

On the computer used for video clip distribution, the video clip generator stills generates a one minute long video clip based on the forwarded sub-portion, which video clip includes titles that give the game, date, and the game's rival teams.

However, the generated video clip includes a ‘Fault???’ title rather than the ‘Fault’ title. Further, the video distributer rather sends the video clip which bears the ‘Fault???’ title only to the few dozens of client devices from which the tags which bear the ‘Fault’ event of the one minute period originate.

Thus, optionally, the video distributer selects one or more recipients for the sub-portion, according to at least one of the received tags, and the video clip generated at least from the sub-portion, is provisioned to the selected recipients only.

Optionally, each one of the client devices (say a smart phone or a tablet computer) is provided with a GUI (Graphical User Interface), as described in further detail hereinbelow.

The GUI is operable on the client device, by the client device's user, for generating and sending the tag to the server computer upon actuation of one of a group which consists of one or more graphical elements of the GUI presented on a screen of the user's client device. Each element is associated with a respective event type.

Optionally, the apparatus 1000 further includes a GUI manager (not shown), which provides the GUI to the client device, say on a website accessible by the client device using a web browser (say Google™ Chrome) as known in the art.

In one example, the GUI manager is an application which runs on the server computer and which implements the GUI on a website accessed by the client device, as described in further detail hereinbelow.

Alternatively, the GUI is rather a part of a client application which the user may download from an App Store—such as Apple® App Store or Google® Play, as described in further detail hereinbelow.

When watching the event (say game), the user opens the client application, and the client application presents one or more GUI (Graphical User Interface) elements—say radio buttons, check boxes, options in a menu, etc., on a display of the user's device, as described in further detail hereinbelow.

Each one of the GUI elements is associated with a respective video length predefined by a programmer of the application downloaded to the user's device, or of the GUI manager, as described in further detail hereinbelow.

Upon actuation of one of the GUI elements by the user of the device—say by clicking or touching the GUI element, a tag which bears an indication on the event type is sent to the server computer in communication with the user's client device, as described in further detail hereinbelow.

Optionally, each one of the GUI elements is presented with a marking which indicates the association of the GUI element with a respective one of the event types, as described in further detail hereinbelow.

Thus, in one example, per the predefined event types, during a soccer game attended by a user of one of the client devices, one GUI radio button presented to the user bears the word ‘Goal’, one GUI radio button presented to the user bears the word ‘Offside’, one radio button presented to the user bears the word ‘Attack’, etc., as described in further detail hereinbelow.

In the example, when a player scores a goal captured in the video feed being received by the video feed receiver 101, a user who watches the game may actuate the GUI radio button which bears the word ‘Goal’. Upon the actuation of the radio button by the user, a tag which bears the ‘Goal’ event type indication is sent to the server computer and is received by the tag receiver 103.

Similarly, in the example, when the user rather actuates the GUI radio button which bears the word ‘Attack’, a tag which bears the ‘Attack’ event type indication is sent to the remote server computer and received by the tag receiver 103.

Optionally, the GUI's graphical elements are selected dynamically, and each one of the graphical elements is dynamically associated with a respective event type, on basis of the device's location, on basis of data input by the device's user (say to the GUI manager or to the client application), as described in further detail hereinbelow.

The dynamic selection of the GUI elements and associated event types may be carried out by the client application downloaded from the App Store, which application implements the GUI on the user's smart phone, by the GUI manager implemented on the server computer, etc., as described in further detail hereinabove.

Optionally, the apparatus 1000 further includes a GUI definition data provider (not shown).

In a first example, just before the game begins, the GUI definition data provider provides each client device—which according to GPS data sent from the client device to the server computer, is present at the facility (say stadium) in which the event (say game) is to take place—with GUI definition data.

The GUI definition data defines one or more of the GUI elements, one or more of the event types each of which types is associated with a respective one of the GUI elements, etc., or any combination thereof.

In a one example, upon opening of a client application which runs on the user's client device, location data generated on the user's device, which may include, but is not limited to: GPS data, DGPS (Differential GPS) data, is automatically and periodically communicated to the server computer.

Consequently, based on the communicated location data, the GUI definition data provider generates GUI definition data which defines one or more of the video lengths, one or more of the GUI elements, one or more of the event types each of which event types is associated with a respective one of the GUI elements, etc., or any combination thereof.

The GUI definition data provider sends the generated GUI definition data to the user's device, and the GUI definition data is received on the client device, by the client application which runs on the user's client device.

The client application uses the GUI definition data to generate and present the GUI elements, and upon actuation of one of the elements by the user (say by touch), to forward a tag which bears an indication on the event type associated with the actuated element, to the server computer, as described in further detail hereinabove.

Optionally, the client application further allows the user to input a sport type (say ‘Football’).

Based on the input sport type, the client application automatically selects one or more of the GUI elements, one or more of the event types, etc., or any combination thereof. The selection may be based on GUI definition data already embedded in the client application's programming code or rather on GUI definition data which originates from the server computer, as described in further detail hereinabove.

Optionally, the tag receiver 103 further receives a respective video clip with each specific one or more of the received tag, say a video file in which the specific tag is implemented in the file's a name, metadata, etc.

Thus in one example, the file name may bear the event type indication, the file's time of creation may serve as the time indication, and GPS data inserted by the client application in the video file (say as a small title presented in some of video frames in the file) may serve as the location indication.

Consequently, the video clip generator generates a compound video clip, by combining the video clip received with the tag with the sub-portion forwarded on basis of an event determined by the event determiner 104 on basis of the tag received with the video clip. Then, the video distributer distributes the compound video clip to one or more of the client devices, as described in further detail hereinbelow.

Optionally, the video clip generator rather generates the compound video clip from two or more video clips, each of which video clips is received with a respective one of the tags.

The video clip generator generates the compound video clip by combining the received video clips with the forwarded sub-portion, based on a correlation which the event determiner 104 finds among the tags received with the combined video clips, say for determining an event type occurrence, as described in further detail hereinbelow.

Thus, in one example, the compound video clip is based on a video sub-portion forwarded for further processing on basis of tags received with video clips captured by two smart phones, which according to GPS data received in the tags, are simultaneously present at the same sport facility, say stadium, during a specific soccer game.

In the example, the compound video clip includes the two clips concatenated with the forwarded video sub-portion, and bears titles based on the event determined on basis of the two tags, as well as tittles which identify the game, rival teams, etc., as described in further detail hereinbelow.

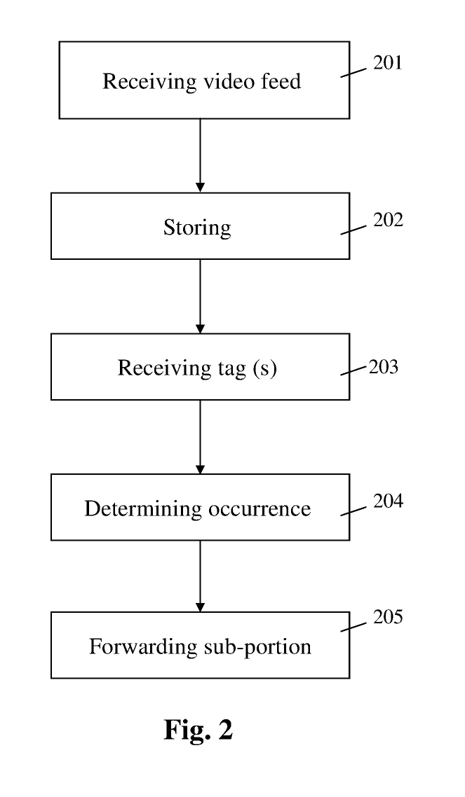

Reference is now made to FIG. 2, which is a simplified flowchart schematically illustrating an exemplary method for crowd-sourced video generation, according to an exemplary embodiment of the present invention.

An exemplary method for crowd-sourced video generation, according to an exemplary embodiment of the present invention, may be executed by one or more computer processors of a group of one or more computers used as the server computer of the present embodiment.

In a first example, the server computer is deployed at a facility such as a sport stadium in which a sport event such as a game of football or soccer takes place or at control room remote from the stadium, at a lecture room, etc., as described in further detail hereinbelow.

In the example, the server computer communicates with one or more cameras in use at the facility (say the sport stadium), say with one or more professional TV cameras installed at the facility, over a wired or wireless network, as known in the art.

In the example, the server computer further communicates with multiple client devices, say smart cellular phones or tablet computers, which are in use by users present at the stadium during the sport event, by users who watch the sport event on TV or over the internet, etc., or any combination thereof.

During the sport event, on the server computer, there is received 201 a feed of video captured by the camera. Optionally, the video feed is received 201 by the video feed receiver 101, as described in further detail hereinabove.

During the receiving 201 of the video feed, there is stored 202 at least a portion of the video feed being received 201 on a memory of the server computer, say by the memory maintainer 102, as described in further detail hereinabove.

Optionally, the portion of the video feed is stored 202 on the server computer's memory, in one or more buffers maintained (say by the memory maintainer 102), on the server computer's memory, as described in further detail hereinabove.

At least one of the buffers stores a most recent portion of the video feed being received 201—say the last ten minutes of video feed received 201 by the video feed receiver 101, as described in further detail hereinabove.

Optionally, throughout at least a part of the receiving 210 of the video, there are maintained at least two buffers which span partially overlapping time frames, as described in further detail hereinbelow, and as illustrated using FIG. 5.

During the game, there may be received 203 one or more tags. Each one of the tags is received 203 from a respective one of the client devices in communication with the server computer while the user of the client device watches the game, say from a seat in the stadium or rather from home (say on a TV Channel or on a web site).

Optionally, the tags are received 203 by the tag receiver 103, as described in further detail hereinbelow.

Thus, in one example, when a user of a client device who watches the game, sees that the user's son who happens to play in one of the game's rival teams, catches the ball, the user sends a tag to the server computer.

Optionally, for generating and sending the tag, the user pushes a specific one of a few buttons presented in a GUI (Graphical User Interface) provided to the user on the user's client device (say the user's smart phone), as described in further detail hereinbelow.

Consequently, a tag which contains the text of ‘my boy has the ball’ or another event type indication (say a code predefined by a user or a programmer of a program which implements the GUI on the user's client device) is sent to the server computer, as described in further detail hereinbelow.

Based on the received 203 one or more tags, there may be determined 204 an occurrence of a predefined event type, say by the event determined 104, as described in further detail hereinabove.

Optionally, the determining 204 of the occurrence is based on an event type indication received 203 in one or more of the tags.

Thus, for example, a ‘my boy has the ball’ event may be determined 204 based on the tag of the above made example (i.e. the ‘my boy has the ball’ text or another event type indication included in the tag of the example).

Optionally, the determining 204 is further based on a correlation found between an event type indication received in a first one of the tags and an event type indication received in a second one of the tags, say by the event determiner 104, as described in further detail hereinabove.

Optionally, the correlation is found among event type indications received in several ones of the received 203 tags, as described in further detail hereinabove.

Thus, in one example, when a tag which bears a ‘Goal’ text (which text thus serves as an indication of a Soccer Goal event type) is received 203 only from a single client device, no Goal event is determined 204.

However, when tags bearing a ‘Goal’ text are received 203 from several ones of the client devices, a Goal event is determined 204 based on the receive 203 tags, provided that the tags are received 203 from client devices simultaneously present at the same facility, as described in further detail hereinabove.

Optionally, the method further includes receiving 203 a time indication in at least one of the tags, and the determining 204 of the occurrence of the event type is further based on the received 203 time indication. For example, the time indication may mark a time which is within a predefined time period of a soccer game as input in advance, say by a programmer of the server computer, as described in further detail hereinabove.

Optionally, the determining 204 of the event type is further based on a correlation found between a time indication received 203 in a first one of the tags and a time indication received 203 in a second one of the tags, as described in further detail hereinabove.

Optionally, the determining 204 of the event type is further based on a correlation found among time indications received 203 in several ones of the tags.

Optionally, the determining 204 of the occurrence of the event type is further based on a time of receipt 203 of one or more of the tags—say by giving less weight to tags received 203 too shortly after an event of the same sort (say a goal) has already been determined 204, while giving more weight to tags which are received 203 later.

Optionally, the determining 204 is further based on a correlation found between a time of receipt 203 of a first one of the tags and a time of receipt 203 of a second one of the tags, or on a correlation found among times of receipt 203 of several ones of the received 203 tags, as described in further detail hereinabove.

Thus, in one example, the determining 204 of an occurrence of a Goal is made only if the number of tags indicating a Goal event, which tags are received 203 within a period of one minute, exceeds a threshold predefined by a programmer or administrator, as described in further detail hereinbelow.

Optionally, the method further includes receiving 203 a location indication in at least one of the tags, and the determining 204 of the occurrence of the event type is further based on the received 203 location indication.

Thus, in one example, in order to be taken into consideration for the determining 204, the location indication needs to mark a location which is within an area of a stadium in which a soccer game takes place, as defined by an administrator of the server computer, as described in further detail hereinbelow.

Optionally, the determining 204 of the event type is further based on a correlation found between a location indication received 203 in a first one of the tags and a location indication received 203 in a second one of the tags, and optionally, on a correlation found among location indications received 203 in several ones of the tags.

For example, in the determining 204, there may be given a higher weight to tags received 203 from client devices which according to the location indications in the received 203 tags, are positioned closer to one of the soccer gates.

Optionally, the occurrence is determined 204 by the event determiner 104, as described in further detail hereinbelow.

In the exemplary method, each event type may be associated with a respective video length.

Thus, in a first example, the method further includes a preliminary step in which an administrator or a programmer (say of apparatus 1000) assigns a specific video length to each one of a group of event types predefined by the administrator or programmer.

Additionally or alternatively, the programmer or administrator may pre-define a default length which applies to all event types, such that unless being assigned with a video length specific to the event type, an event type is associated with that default predefined length.

In the method, based on the determined 204 occurrence, there is forwarded 205 a sub-portion of the video feed portion stored 202 on the memory for further processing, say by the forwarder 105, as described in further detail hereinabove.

The forwarded 205 sub-portion has a video length predefined for the event type of the determined 204 occurrence, as described in further detail hereinabove.

Optionally, the forwarding 205 includes communicating the sub-portion to a computer remote from the server computer—say to the computer used for distributing video, to be further processed on the computer used for distributing video, as described in further detail hereinabove.

In one example, the sub-portion is communicated to the remote computer over a VPN (Virtual Private Network), as described in further detail hereinbelow.

Optionally, the further processing is rather carried out by the server computer itself, say by the video clip generator and video distributer, as described in further detail hereinabove.

Optionally, the forwarder 105 forwards 205 the sub-portion from the buffer which stores 202 a most recent portion of the received 201 video feed, as described in further detail hereinabove.

Thus, in one example, the forwarder 105 forwards 205 a sub-portion of the video feed portion stored 202 in the buffer for further processing. In the example, the forwarded 205 sub-portion has a video length of two minutes, as assigned by the administrator to the specific ‘my boy has the ball’ event type in the preliminary step, as described in further detail hereinabove.

In the example, the sub-portion spans over a two minutes long time period immediately before the tag's receipt 203. Consequently, the event of the user's boy having the ball is more likely to be included in the forwarded 205 sub-portion, in spite of a likely delay in the user's reacting to the event by pushing of the right GUI radio button, for sending the tag, as described in further detail hereinabove.

In the example, the further processing involves generating a two minutes long video clip which is based on the forwarded 205 sub-portion of the video, and which includes titles which give the game, game date, rival teams, as well as a ‘my boy has the ball’ title.

Further in the example, a link usable for downloading the video clip is sent to the user's smart phone which the received 203 tag originates from, say in an SMS (Short Message Service) or an email message, and the user may forward the email to his family, friends, etc., say a few minutes after the occurrence.

Alternatively or additionally, the video clip may be distributed to one or more recipients directly from the server computer, say over the internet and using a recipients list predefined by the smart phone's user through remote access to the server computer, say on a website implemented on the remote computer.

Optionally, the sub-portion is rather forwarded 205 directly (say over the interne) to one or more of the client devices. Then, an application which runs on each specific one of the client devices which are sent the sub-portion, further processes the sub-portion (say by adapting the sub-potion for presentation on the specific device's screen), and presents the sub-portion on the client device's screen.

In a second example, at least some of the client devices are indentified as being used by audience members who attend a same concert, game, etc., using GPS (Global Positioning System) or other location data included in the tags received 203 from the identified client devices, during the game or concert.

In the second example, each specific one of the tags includes an event type, a time stamp which marks the time in which the specific tag is generated, and GPS data which reveals the location of the client device which the specific tag originates from, when the client device sends the specific tag.

Consequently, tags which bear GPS data which indicates a location within a same stadium and time stamps which mark a time in overlap with a time period in which a video feed of a specific event is received 201—say during a specific soccer game played in the stadium—are taken into consideration for determining 204 event types' occurrences during the specific event (say the game of soccer).

In the example, when several hundreds of the tags taken into consideration bear a ‘Fault’ event type indication, and are received 203 within a period of one minute (separating the earliest and latest ones of the tags bearing the ‘Fault’ event type indications), there is determined 204 a ‘Fault’ event occurrence.

Consequently, there is forwarded 205 a one minute long sub-portion of the video portion stored 202 on the memory of the server computer to a computer used for video clip distribution, going from the time of receipt 203 of a median one of the tags (in as far as the tags' order of receipt 203 is concerned) backwards.

On the computer used for video clip distribution, the sub-portion is used to generate a one minute long video clip which is based on the forwarded 205 sub-portion of the video, and which includes titles which give the game, game date, rival teams, etc., as well as a ‘Fault’ title.

Then or later, the one minute long video clip which bears the title ‘Fault’ is sent to each one of the client devices which according to the location data (say GPS) included in the tag received 203 from the client device, is present at the sport stadium in which the game takes place.

However, when only a small number of the tags (say a few dozens) taken into consideration on basis of their concurrent presence at the stadium during the game, bear a ‘Fault’ event and are received 203 within a period of one minute, there is determined 204 that an occurrence of a ‘Fault in question’ event type.

Consequently, there is still forwarded 205 a one minute long sub-portion of the video portion stored 202 on the memory of the server computer to the computer used for video clip distribution, going from the time of receipt 203 of a median one of the tags backwards.

On the computer used for video clip distribution, the sub-portion is still used to generate a one minute long video clip based on the forwarded 205 sub-portion of the video, which includes titles that give the game, date, and the game's rival teams. However, the generated video clip includes a ‘Fault???’ title rather than the ‘Fault’ title.

Further, the server computer used for video clip distribution sends the video clip which bears the ‘Fault???’ title, but only to the few dozens of client devices from which the tags which bear the ‘Fault’ event of the one minute period originate.

Thus, optionally, in the method, there is selected one or more recipients for the sub-portion, according to at least one of the received 203 tags, and the video clip generated at least from the sub-portion, is provisioned to the selected recipients.

Optionally, the method further includes a preliminary step in which each client device (say a smart phone or a tablet computer) in communication with the server computer, is provided with a GUI (Graphical User Interface), as described in further detail hereinabove.

The GUI is operable on the client device, by the client device's user, for generating and sending the tag to the server computer upon actuation of one of a group which consists of one or more graphical elements of the GUI presented on a screen of the user's client device. Each element is associated with a respective event type.

In one example, the GUI is provided to the client device, using a website accessible by the client device.

In another example, the GUI is provided to the client device by providing a client application to the client device. In the example, the GUI is a part of a client application which the user may download from an App Store—such as Apple® App Store or Google® Play, as described in further detail hereinabove.

In the example, when watching the event (say game), the user opens the client application, and the client application presents one or more GUI (Graphical User Interface) elements—say radio buttons, check boxes, options in a menu, etc., as known in the art—on a display of the user's device.

Each one of the GUI elements is associated with a respective video length predefined say by a programmer of the application downloaded to the user's device, as described in further detail hereinbelow.

Upon actuation of one of the GUI elements by the user of the device—say by clicking or touching the GUI element, a tag which bears an indication on the event type is sent to the server computer in communication with the user's client device, as described in further detail hereinabove.

Optionally, each one of the GUI elements is presented with a marking which indicates the association of the GUI element with a respective one of the event types, as described in further detail hereinbelow.

Each one of the event types may be predefined for a specific one of the GUI elements, say by the administrator or the programmer, as described in further detail hereinbelow.

Thus, in a first example, per the predefined event types, during a soccer game attended by a user of one of the client devices, one GUI radio button presented to the user bears the word ‘Goal’, one GUI radio button presented to the user bears the word ‘Offside’, one radio button presented to the user bears the word ‘Attack’, etc., as described in further detail hereinbelow.

In the first example, when a player scores a goal captured in the received 201 video feed, a user who watches the game may actuate the GUI radio button which bears the word ‘Goal’ and is resented on the user's client device (say smart phone). Then, upon the actuation of the radio button by the user, a tag which bears the ‘Goal’ event type indication is sent to the server computer from the user's client device.

Similarly, when the user rather actuates the GUI radio button which bears the word ‘Attack’, a tag which bears the ‘Attack’ event type indication is sent to the remote server computer.

Optionally, the GUI is made of dynamically selected graphical elements and each graphical element is dynamically associated with a respective event type, on basis of the device's location, on basis of data input by the device's user, etc., or any combination thereof, as described in further detail hereinabove.

For example, the dynamic selection of the GUI elements and associated event types may be carried out by an application which implements the GUI on the user's client device (say smart phone), by an application which runs on the server computer and implements the GUI on a website accessed by the client device, etc., as described in further detail hereinabove.

Optionally, just before the game begins, each client device which according to GPS data sent from the client device to the server computer is present at the stadium in which the game is to take place, is provided with GUI definition data sent from the server computer.

The GUI definition data defines one or more of the GUI elements, one or more of the event types each of which event types is associated with a respective one of the GUI elements, or any combination thereof, as described in further detail hereinabove.

The received GUI definition data may include definitions already embedded in an application downloaded to the client device—say from an App Store (say from Apple® App Store), as described in further detail hereinabove.

Alternatively or additionally, the received definition data may include definitions communicated from a remote server of third party—say from a remote server of a service provider, upon opening the downloaded application, just before the game's beginning, as described in further detail hereinabove.

In a first example, upon opening of the application on the user's client device, location data generated on the user's device, which may include, but is not limited to: GPS data, DGPS (Differential GPS) data, or another location data, is automatically and periodically communicated to the server computer.

Consequently, based on the communicated location data, on the server computer, there is generated GUI definition data which defines one or more of the video lengths, one or more of the GUI elements, one or more of the event types associated with a respective one of the GUI elements, etc., or any combination thereof, as described in further detail hereinabove.

The definition data generated on the server computer is sent to the user's device, and is received by the client application which runs on the user's client device.

The client application uses the GUI definition data to generate and present the GUI elements, and upon actuation of one of the elements by the user (say by touch), to forward a tag which bears an indication on the event type associated with the actuated element, to the server computer, as described in further detail hereinabove.

In a second example, the a user of the device is allowed (say by the client applcation) to input a sport type (say ‘Football’), and based on the input sport type, the client application automatically selects one or more of the GUI elements, one or more of the event types, etc., or any combination thereof.

In a third example, the user of the device is allowed to input a code—say a code given to the user at a stadium at which a Football Match attended by the user takes place, and the client application forwards the user-input code the server computer, as described in further detail hereinabove.

Consequently, on the remote server computer, there is generated GUI definition data which defines one or more of the GUI elements, one or more of the event types associated with a respective one of the GUI elements, or any combination thereof, and sent to the user's client device (say smart phone or tablet computer).

On the user's client device, the client application uses the GUI definition data, to generate and present the GUI elements, and upon actuation of one of the elements by the user, to send a tag which bears an indication on the event type associated with the actuated element, to the server computer.

Optionally, one or more of the client devices, sends a video clip with the tag, say a video file in which the tag is implemented in the file's a name or metadata.

Thus in one example, the file name may bear the event type indication, the file's time of creation may serve as a time indication, and GPS data inserted by the client application in the file (say as titles in some of the file's video frames) may serve as the location indication, as described in further detail hereinabove.

Consequently, the video clip is received 203 with the tag on the server computer, and is later on combined on the server computer, with a stored 202 video portion's sub-portion forwarded 205 into a compound video clip, on basis of an event type occurrence determined 204 using the tag received 203 with the video clip.

Then, the compound video clip may be provisioned from the server computer to one or more of the client devices, as described in further detail hereinbelow.

Optionally, the compound video clip is rather generated by the computer used for video distribution to which the sub-portion is forwarded 205 from the server computer, by combining the sub-portion and the user's video clip, as described in further detail hereinabove.

Optionally, the compound video clip is rather generated from two or more video clips, each of which video clips is received 203 with a respective one of the tags.

The video clip is generated by combining the received 203 two or more video clips with the forwarded 205 sub-portion into a compound video clip based on a correlation among the tags received 203 with the combined video clips, as described in further detail hereinbelow.

Thus, the compound video clip may be based on video clips received 203 with tags, from different ones of the client devices, say from client devices in predefined proximity to each other.

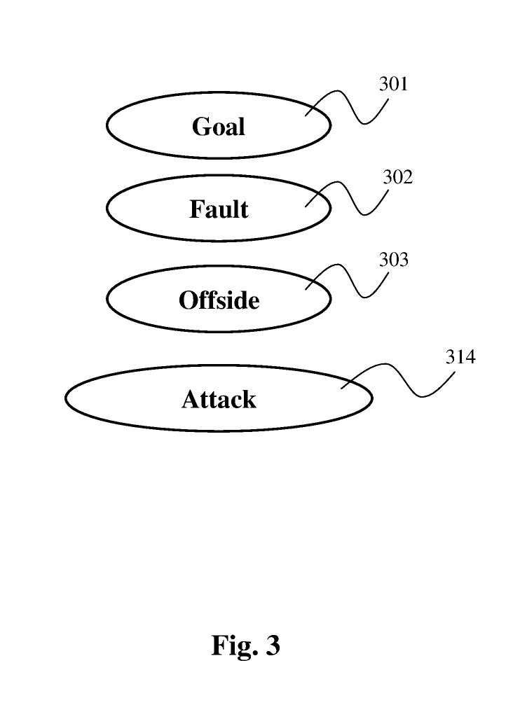

Reference is now made to FIG. 3, which is a block diagram schematically illustrating a first exemplary GUI for crowd-sourced video generation, according to an exemplary embodiment of the present invention.

In one exemplary embodiment, during a soccer game played between FC Barcelona and Real Madrid and attended by a fan, on a server computer in communication with the fan's mobile smart phone, there is received, say by the video feed receiver 101, a feed of video captured by video camera of a TV crew during the game.

As the video feed captured by a camera is being received, there are maintained one or more buffers, say by the memory maintainer 102, as described in further detail hereinabove.

In the exemplary embodiment, the buffer stores at least a portion of the received video feed, say the most recent ten minutes of the video being received by the video feed receiver 101.

During receipt of the video feed, there are presented on a display of the fan's mobile smart phone, say by a client application installed on the smart phone, one or more GUI elements 301-314 (say a few buttons, menu options, etc.), as known in the art.

Each one of the GUI elements 301-314 is associated with a respective event type, as described in further detail hereinabove.

Each one of the GUI elements 301-314 is presented to the fan, on the screen of fan's smart phone, with a marking which indicates the association of the GUI element with the respective event type.

Thus, in the example, per the predefined event types, during the game, one GUI element 301 bears the word ‘Goal’, one GUI element bears the word ‘Fault’ 302, one GUI element 303 bears the word ‘Offside’ 314, and one GUI element 301 bears the word ‘Attack’.

Upon actuation of one of the GUI elements 301-314 by the fan—say by touching one of the GUI's radio buttons 301-314, there is sent a tag which includes an event type indication which identifies the event type, to the server computer, as described in further detail hereinabove.

Thus, for example, when a one of the players scores a goal, the fan actuates (say by touching) the button which bears the word ‘Goal’, and a tag bearing the word ‘Goal’ is sent from the client device, say over the internet, to the remote server computer, as described in further detail hereinabove.

Upon receipt of the tag on the server computer, say by the tag receiver 103, there is determined an occurrence of an event type (say a Goal), say by the event determiner 104, as described in further detail hereinabove.

Consequently, a sub-portion of the video portion stored on the server computer's memory (say the buffer) is forwarded for further processing, say by the forwarder 105.

The forwarded sub-portion is of a length (say two minutes) as predefined for the specific event type in a preliminary step, say by the administrator or programmer of apparatus 1000, as described in further detail hereinabove.

In one example, the sub-portion is further processed by generating a two minutes long video clip from the sub-portion. Optionally, the video clip is added titles which describe the type of event (say ‘Goal’ or ‘Attack’) associated with the GUI element actuated by the fan, as well as additional titles such as ‘Real Madrid vs. FC Barcelona’, a date, etc.

Finally, the server computer sends an email message bearing a link usable for downloading the video clip to every client device which, according to GPS data included in tag received from the client device, is present at a stadium at which the game takes place, during the game, as described in further detail hereinabove.

The video clip distributed as an email attachment may thus be focused at a very specific moment of interest (say a goal, a fault, etc.). Further, bandwidth consumed by the smart phones when downloading the video clip is reduced to the bandwidth needed for the two minutes of the sub-portion of interest.

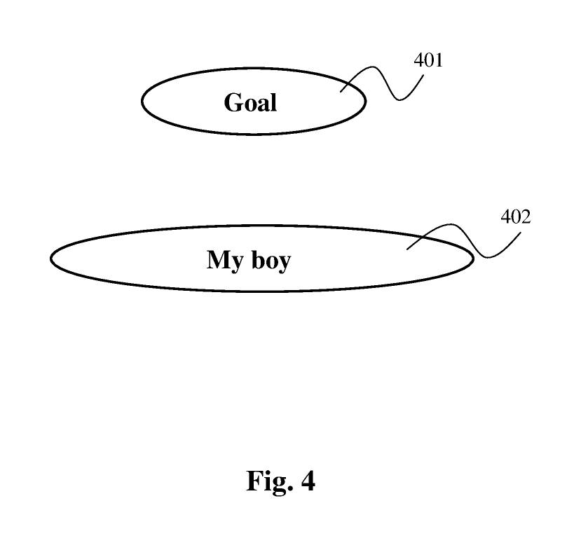

Reference is now made to FIG. 4, which is a block diagram schematically illustrating a second exemplary GUI for crowd-sourced video generation, according to an exemplary embodiment of the present invention.

A second exemplary GUI, according to an exemplary embodiment of the present invention, is rather focused at events of a more private nature.

Thus, in one example, a mother attends an amateur Football Game between two schools, at a stadium.

During the game, a server computer installed at the stadium, which server computer implements apparatus 1000, is continuously fed a feed of video of the game as captured by a camera deployed at the stadium.

As the video feed captured by a camera is being received by the video feed receiver 101 of apparatus 1000, the memory maintainer maintains one or more buffers, which buffer stores the most recent five minutes of the video being received by the video feed receiver 101.

During receipt of the video feed, there are presented on a display of the mother's mobile smart phone, two GUI elements 401-402 (say a as two buttons), as known in the art.

Each one of the GUI elements 401-402 is associated with a respective predefined event type, as described in further detail hereinabove.

Further in the example, each one of the GUI elements 401-402 is presented to the mother with a marking which indicates the association of the GUI element with the respective event type predefined for the GUI element.

Thus, in the example, per the predefined event types, during the game, a first GUI element 401 presented to the mother on her smart phone's display bears the word ‘Goal’, while a second GUI element 402 presented to the mother bears the word ‘My boy’ 402.

In the example, when one of the players scores a goal, the mother actuates (say by touching) the button which bears the word ‘Goal’.

Consequently, a tag bearing the word ‘Goal’ is sent from the mother's smart phone to the server computer.

Upon receipt of the tag bearing the word ‘Goal’ by the tag receiver 103, the event determiner 104 determines an occurrence of a Goal event, and a sub-portion of a length predefined for the Goal events is forwarded for further processing—say for generation of a video clip based on the sub-portion, as described in further detail hereinabove.

However, when her son receives the ball, the mother rather actuates the button which bears the words ‘My boy’.

Consequently, a tag bearing the words ‘My boy’ is sent from the mother's smart phone to the server computer.

Upon receipt of the tag bearing the words ‘My boy’ by the tag receiver 103, the event determiner 104 determines an occurrence of an event type of an attendee's boy having the ball, and a sub-portion of a length predefined for that event type is forwarded for further processing—say for the generation of a video clip based on the sub-portion, as described in further detail hereinabove.

Finally, the server computer sends an email message bearing a link usable for downloading the video clip to the mother only, for the mother to forward to one or more recipients, say to a specific friend or family member, as described in further detail hereinabove.

Reference is now made to FIG. 5, which is a block diagram schematically illustrating computer memory buffer usage in performing steps of crowd-sourced video generation, according to an exemplary embodiment of the present invention.

According to an exemplary embodiment, throughout most of the receiving of the video feed, say by video feed receiver 101, there are maintained two buffers which span partially overlapping time frames of five minutes, with dynamic discarding and adding of buffers, as described in further detail hereinbelow.

Thus, in one exemplary scenario, when a receipt of a live video feed on a user's device starts, the memory maintainer 102 opens a first buffer 501, and starts filling the buffer with the live video feed received by the video feed receiver 101 (say with a sequential digital data representation of the feed's frames, as known in the art).

By the end of the first minute of the video feed, the memory maintainer 102 opens a second buffer, and starts filling the second buffer too, with the live video feed received by the feed receiver 101 (starting with the second minute of the live video feed). The memory maintainer 102 thus maintains the two buffers by updating both buffers simultaneously, for the next four minutes.

By the end of the fifth minute, the first buffer 501 is fully filled and stores minutes 1-5 of the video feed, whereas the second buffer 502 stores minutes 2-5 of the video feed (i.e. four minutes) with the last fifth of the second buffer 502 being empty.

At that point (i.e. at the end of the fifth minute of the receiving), the memory maintainer 102 opens a third buffer 503, stops updating the first buffer (now filled) 201, and starts updating the third buffer 503 with the live video feed being received, simultaneously updating the second 502 buffer for the next one minute.

In the next three minutes (i.e. minutes 7-9 of the video feed), the memory maintainer 102 maintains the third buffer 503 only.

By the end of the ninth minute, the third buffer 503 stores minutes 6-9 of the video feed (i.e. four minutes) with the last fifth of the third buffer 503 being empty.

At that point (i.e. at the end of the ninth minute), the memory maintainer 102 opens a fourth buffer 504, starts updating the fourth buffer 504, with the live video feed being received 210, simultaneously updating the third 503 buffer for the next one minute, and so on and so forth, as long as the video feed receipt continues.

In the exemplary scenario, thanks to the at least one minute long overlaps between the buffers (say for the video feed's second, sixth and tenth minute), any event of a length of up to one minute captured in the video feed may be forwarded per a determination of an occurrence of an event type by the event determiner 104.

Specifically, even an event captured at the very beginning of one buffer may be forwarded, since the event is captured in a previous buffer's ending portion.

For example, when the user pushes the ‘Attack’ GUI element 314 presented in the GUI element illustrated in FIG. 3 hereinabove during a second minute of the video feed's receipt by the video feed receiver 101 (say at the 72^{nd} second of the video feed), the second buffer 502 holds only the last twelve seconds.

However, thanks to the overlap, the first buffer holds the entire one minute of video length predefined for to the Attack event type associated with GUI element 314, thus making the forwarding of the one last minute (going from the exact 72^{nd} second backwards) long sub-potion possible.

The longer the overlap between two buffers of concurrent maintenance, say by the memory maintainer 102, the longer is the sub-potion's video length secured thanks to the overlapping.

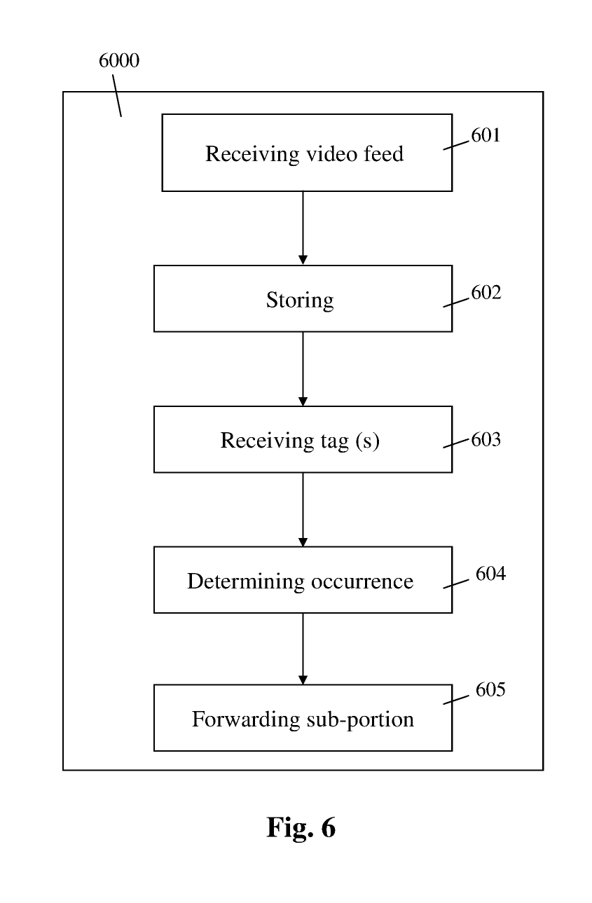

Reference is now made to FIG. 6 which is a block diagram schematically illustrating an exemplary computer readable medium storing computer executable instructions for performing steps of crowd-sourced video generation, according to an exemplary embodiment of the present invention.

According to an exemplary embodiment of the present invention, there is provided a non-transitory computer readable medium 6000, such as a Micro SD (Secure Digital) Card, a CD-ROM, a USB-Memory, a Hard Disk Drive (HDD), a Solid State Drive (SSD), etc.

The computer readable medium 6000 stores computer executable instructions, for performing steps of crowd-sourced video generation.

The instructions may be executed upon one or more computer processors, say on a computer processor of a server computer in use by a TV Channel team, as described on further detail hereinabove.

For carrying out the steps, the computer processor communicates with one or more cameras (say with a professional video camera of a TV Channel deployed at a sport stadium), for receiving a video feed captured live during the event (say game of sport, a seminar, a lecture, a speech, etc.), as described in further detail hereinabove.

Further, the computer processor communicates with one or more client devices (say smart phones, tablet computers, etc.), as described in further detail hereinabove.

The computer executable instructions include a step of receiving 601 a feed of video captured by the camera during the event (say game of soccer), as described in further detail hereinabove.

The computer executable instructions further include a step of storing 602 at least a portion of the video feed being received 601 on a memory of the server computer, during the receiving 601 of the video feed, as described in further detail hereinabove.

Optionally, the step includes storing 602 the portion of the video feed on the server computer's memory, in one or more buffers maintained on the server computer's memory, as described in further detail hereinabove.

At least one of the buffers stores a most recent portion of the video feed being received 601—say the last ten minutes of the received 601 video feed, as described in further detail hereinabove.

Optionally, throughout at least a part of the receiving 601 of the video, there are maintained 602 two buffers which span partially overlapping time frames, as described in further detail hereinbelow, while dynamically discarding and adding buffers, as illustrated using FIG. 5.

The computer executable instructions further include a step of receiving 603 one or more tags during the event (say game).

Each one of the tags is received 603 from a respective one of the client devices in communication with the server computer while the user of the client device watches the even (say game), say from a seat in the stadium or rather from home (say on a TV Channel or on a website).

Thus, in one example, when a user of a client device who watches the game, sees that the user's son who happens to play in one of the game's rival teams, catches the ball, the user sends a tag, for the server computer to receive 603.

Optionally, for generating and sending the tag, the user touches a specific one of a few buttons presented in a GUI (Graphical User Interface) provided to the user on the user's client device (say the user's smart phone), say in a client software as described in further detail hereinabove.

Consequently, in the example, a tag which contains the text of ‘my boy has the ball’ or another event type indication is sent for the server computer to receive 603, as described in further detail hereinabove.

The computer executable instructions further include a step of determining 604 an occurrence of a predefined event type, based on the received 603 one or more tags, as described in further detail hereinabove.

The determining 604 of the occurrence of the predefined event type may be based on one or more indications included in the received 604 tag, say on an event type indication, a location indication, a time indication, etc., or on a correlation found among two or more of the tags' indications, as described in further detail hereinabove.

Additionally or alternatively, the determining 604 of the occurrence of the predefined event may be based on the tag's time of receipt 603, or on a correlation found among two or more of the tags' indications, as described in further detail hereinabove.

Each event type may be associated with a respective video length.

Thus, in a first example, the computer executable instruction further include a preliminary step in which an administrator or a programmer assigns a specific video length to each one of a group of event types predefined by the administrator or programmer.

Additionally or alternatively, the programmer or administrator may pre-define a default length which applies to all event types, such that unless being assigned with a video length specific to the event type, an event type is associated with that default predefined length.

The computer executable instructions further include a step of forwarding 605 a sub-portion of the video feed portion stored 602 on the memory for further processing, based on the determined 604 occurrence, as described in further detail hereinabove.

The forwarded 605 sub-portion has a video length predefined for the event type of the determined 604 occurrence, as described in further detail hereinabove.

Optionally, the forwarding 605 includes communicating the sub-portion to a remote computer in communication with the server computer, say to a computer used for video distribution computer, for the further processing, as described in further detail hereinabove.

Optionally, the sub-portion is distributed to the remote computer over a VPN (Virtual Private Network), as described in further detail hereinabove.

Optionally, the further processing is rather carried out by the server computer itself, as described in further detail hereinabove.

Optionally, the computer executable instructions include instructions for forwarding 605 the sub-portion from the buffer which stores a most recent portion of the video feed being received 601, as described in further detail hereinabove.

Thus, in one example, the computer executable instructions include a forwarding 605 of a sub-portion of the video feed portion stored 602 in the buffer for further processing. In the example, the forwarded 605 sub-portion has a video length of two minutes, as assigned by the administrator to the specific ‘my boy has the ball’ event type in the preliminary step, as described in further detail hereinabove.

In the example, the sub-portion spans over a two minutes long time period immediately before the tag's receipt 603. Consequently, the event of the user's boy having the ball is more likely to be included in the forwarded 605 sub-portion, in spite of a likely delay in the user's reacting to the event by pushing of the right GUI radio button, for sending the tag, as described in further detail hereinabove.

In the example, the computer executable instructions further include a step of carrying out the further processing by generating a two minutes long video clip which is based on the forwarded 605 sub-portion of the video, and which includes titles which give the game, game date, rival teams, as well as a ‘my boy has the ball’ title.

Further in the example, the computer executable instructions further include a step of sending a link usable for downloading the video clip to the user's smart phone which the received 603 tag originates from, say in an SMS (Short Message Service) or an email message, and the user may forward the email to his family, friends, etc.

Alternatively or additionally, the computer executable instructions further include a step of distributing the video clip to one or more recipients directly from the server computer, say using a recipients list predefined by the smart phone's user on a website, as described in further detail hereinabove.

Optionally, the sub-portion is rather forwarded 605 directly to one or more of the client devices (say over the internet). Then, an application which runs on each specific one of the client devices which are sent 605 the sub-portion further processes the sub-portion (say by adapting the sub-potion for presentation on the specific device's screen), and presents the sub-portion on the client device's screen.

Optionally, the computer executable instructions further include a step of selecting one or more recipients for the sub-portion or the generated video clip, according to at least one of the received 603 tags, as described in further detail hereinabove.

Optionally, the computer executable instructions further include a preliminary step in which each client device (say a smart phone or a tablet computer) in communication with the server computer, is provided with a GUI (Graphical User Interface), as described in further detail hereinabove.

The GUI is operable on the client device, by the client device's user, for generating and sending the tag to the server computer upon actuation of one of a group which consists of one or more graphical elements of the GUI presented on a screen of the user's client device, as described in further detail hereinabove.

Each element is associated with a respective event type, as described in further detail hereinabove.

In one example, the GUI is provided to the client device, using a website accessible by the client device, as described in further detail hereinabove.

In another example, the GUI is provided to the client device by providing a client application to the client device. In the example, the GUI is a part of a client application which the user may download from an App Store—such as Apple® App Store or Google® Play, as described in further detail hereinabove.

In the example, when watching the event (say game), the user opens the client application, and the client application presents one or more GUI (Graphical User Interface) elements—say radio buttons, check boxes, options in a menu, etc., as known in the art—on a display of the user's device.

Each one of the GUI elements is associated with a respective video length predefined (say by a programmer of the application downloaded to the user's device), as described in further detail hereinabove.

Upon actuation of one of the GUI elements by the user of the device—say by clicking or touching the GUI element, a tag which bears an indication on the event type is sent to the server computer in communication with the user's client device, as described in further detail hereinabove.

Optionally, each one of the GUI elements is presented with a marking which indicates the association of the GUI element with a respective one of the event types, as described in further detail hereinbelow.

Each one of the event types may be predefined for a specific one of the GUI elements, say by the administrator or the programmer, as described in further detail hereinbelow.

Optionally, the GUI is made of dynamically selected graphical elements and each graphical element is dynamically associated with a respective event type, on basis of the device's location, on basis of data input by the device's user, etc., or any combination thereof, as described in further detail hereinabove.

The dynamic selection of the GUI elements and associated event types may be carried out by an application which implements the GUI on the user's smart phone (say the client application) or rather by the computer executable instructions, on the server computer, as described in further detail hereinabove.

Thus, in one example, the computer executable instructions include a step in which, just before the event (say soccer game) begins, each client device which according to GPS data sent from the client device to the server computer is present at the facility in which the game is to take place, is provided with GUI definition data.

The GUI definition data defines one or more of the GUI elements, one or more of the event types each of which event types is associated with a respective one of the GUI elements, or any combination thereof, as described in further detail hereinabove.

Optionally, one or more of the client devices, sends a video clip with the tag, say a video file in which the tag is implemented in the file's a name or metadata, which video clip is received 603 on the server computer, together with the tag.

Thus in one example, the file name may bear the event type indication, the file's time of creation may serve as a time indication, and GPS data inserted by the client application in the file (say in one or more of the file's video frames) may serve as the location indication.

Consequently, in the example, the video clip received 603 with the tag is later on combined on the server computer, with a stored 602 video portion's sub-portion forwarded 605 on basis of an event determined 604 using the tag received 603 with the vide clip, into a compound video clip, as described in further detail hereinabove.

The compound video clip may be provisioned from the server computer to one or more of the client devices, as described in further detail hereinabove.

Optionally, the compound video clip is rather generated by a computer used for video distribution to which the sub-portion is forwarded 605 from the server computer, by combining the sub-portion and the user's video clip, as described in further detail hereinabove.

Optionally, the compound video clip is rather generated from two or more video clips, each of which video clips is received 603 with a respective one of the tags.

The video clip is generated by combining video clips received 603 with the forwarded 605 sub-portion into a compound video clip, based on a correlation found among the tags received 603 with the video clips—say upon determining an event type occurrence based on the correlation, as described in further detail hereinabove.

Thus, the compound video clip may be based on video clips received 603 with tags, from different ones of the client devices, say from client devices in predefined proximity to each other.

In one example, the compound video clip is based on a video sub-portion forwarded 605 for further processing on basis of tags received 603 with video clips captured by two smart phones, which according to GPS data received 603 in the tags, are simultaneously present at the same sport facility, say stadium.

In the example, the compound video clip includes the two clips concatenated with the forwarded 605 video sub-portion, and bears titles based on the event determined on basis of the two tags, as well as tittles which identify the game, teams, etc., as described in further detail hereinabove.

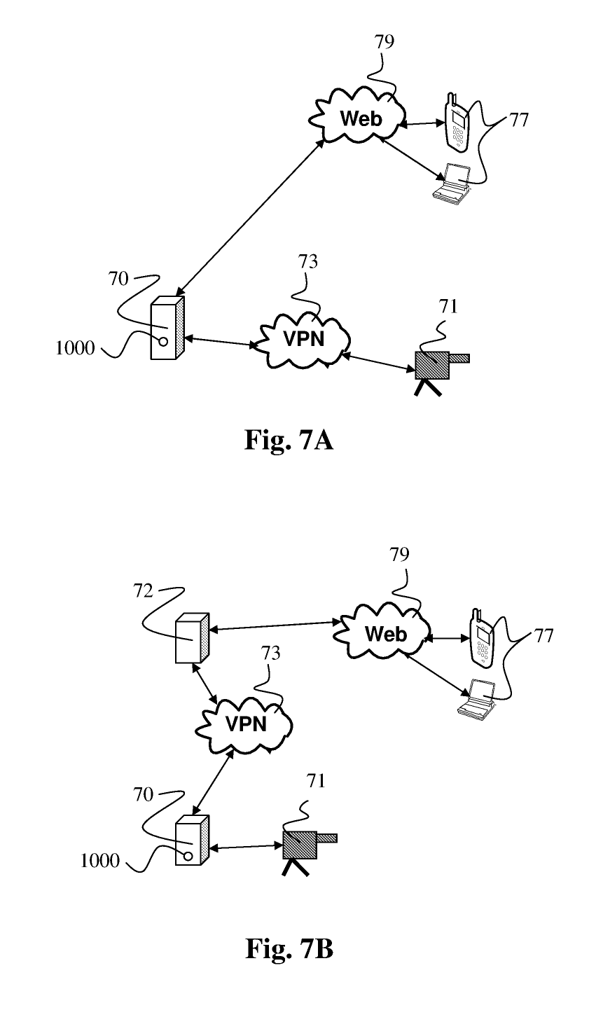

Reference is now made to FIG. 7A, which is a block diagram schematically illustrating a first exemplary implementation scenario of crowd-sourced video generation, according to an exemplary embodiment of the present invention.

In a first exemplary implementation scenario of crowd-sourced video generation, according to an exemplary embodiment of the present invention, apparatus 1000 is implemented on a server computer 70 deployed at a TV Station's office remote from a stadium in which a game of soccer takes place.

In the exemplary scenario, the server computer of 70 is in remote communication with a video camera 71 in use by the TV station's crew, at the stadium, during the game, say over a VPN (Virtual Private Network) 73, as described in further detail hereinabove.

During the game, the apparatus 1000 continuously receives a feed of video of the game as capture by the camera 71, and stores at least a portion of the video feed being received on the server computer's 70 memory, say on one or more buffers, as described in further detail hereinabove.

During the game, the server computer of 70 further communicates with client devices 77 such as smart phones, tablet computers, laptop computers, etc., over a Wide Area Network such as the Web (i.e. the internet) 79, over a cellular telephony network, etc., or any combination thereof.

The client devices 77 are in use by members of the audience—be the members attendees of the football game, who are physically present at the stadium during the game, members of a an audience who watch a broadcast of the game on TV, etc., or any combination thereof.

During the game, the apparatus 1000 implemented on the server computer 70 further receives tags from one or more of the client devices 77. Each one of the tags received from the client devices 77 may bear an event type indication, a location indication, a time indication, etc., or any combination thereof, as described in further detail hereinabove.

Based on the tags' time of receipt, indications (say event type indications), or any combination thereof, the apparatus 1000 implemented on the server computer 70 determines the occurrence of a specific event type, say a Goal.

Consequently, based on that determining, the apparatus 1000 forwards a sub-portion of the video portion stored on the server computer, for further processing. The forwarded sub-portion has the video length predefined for the specific event type, say by a programmer or administrator, as described in further detail hereinabove.

Optionally, the further processing involves a generation of a video clip from the forwarded sub-portion, on the server computer 70, which video clip is distributed to one or more of the client devices 77, say as a link in an email message transmitted over the internet 79, as described in further detail hereinabove.

Reference is now made to FIG. 7B, which is a block diagram schematically illustrating a second exemplary implementation scenario of crowd-sourced video generation, according to an exemplary embodiment of the present invention.

In a second exemplary implementation scenario of crowd-sourced video generation, according to an exemplary embodiment of the present invention, the apparatus 1000 is rather implemented on a server computer 70 deployed at the stadium at which the game of soccer takes place.

In the second scenario, the server computer of 70 is in communication with the video camera 71 in use by the TV station's crew, at the stadium, say over a LAN (Local Area Network) or a wireless connection.

During the game, the apparatus 1000 continuously receives a feed of video of the game as capture by the camera 71, and stores at least a portion of the video feed being received on the server computer's 70 memory, say on a buffer, as described in further detail hereinabove.

During the game, the server computer of 70 further communicates with a second computer 72, say over a VPN (Virtual Private Network) 73, as know in the art.

Optionally, the second computer 72 is a computer which serves to distribute content items such as video clips to client devices 77 (say smart phones, tablet computers, etc.), over a Wide Area Network 79 such as the Web (i.e. internet), a cellular telephony network, etc., as described in further detail hereinabove.

The client devices 77 are in use by members of the audience—be the members attendees of the football game, who are physically present at the stadium during the game, members of a an audience who watch a broadcast of the game on TV, etc., or any combination thereof.

During the game, the apparatus 1000 implemented on the server computer 70 further receives tags from one or more of the client devices 77—indirectly, via the computer 72 which serves to distribute content items such as video clips, and is in direct communication with the client devices 77 (say over the internet 79).

Each one of the tags received from the client devices 77 may bear an event type indication, a location indication, a time indication, etc., or any combination thereof, as described in further detail hereinabove.

Based on the tags' time of receipt, indications (say event type indication), or any combination thereof, the apparatus 1000 implemented on the server computer 70 determines the occurrence of a specific event type, say a Goal, as described in further detail hereinabove.

Consequently, based on that determining, the apparatus 1000 forwards a sub-portion of the video portion stored on the server computer, for further processing on the computer 72. The forwarded sub-portion has the video length predefined for the specific event type, say by a programmer or administrator, as described in further detail hereinabove.

Optionally, the further processing involves a generation of a video clip from the forwarded sub-portion, and the video clip is distributed from the second computer 72 to one or more of the client devices 77, say as a link in an email message transmitted over the internet 79, as described in further detail hereinabove.

It is expected that during the life of this patent many relevant devices and systems will be developed and the scope of the terms herein, particularly of the terms “Computer”, “Camera”, “Smart Phone”, “Tablet Computer”, “Micro SD Card”, “CD-ROM”, “USB-Memory”, “Hard Disk Drive (HDD)”, “Solid State Drive (SSD)”, and “Computer Processor”, is intended to include all such new technologies a priori.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

1-22. (canceled)

23. A computer implemented method of crowd-sourced video generation, comprising:
by a server computer in communication with a plurality of remote client devices, receiving a feed of video captured by a camera;
on a memory of the server computer, storing at least a portion of the video feed being received;
receiving at least one tag from a respective one of the client devices;
determining an occurrence of an event type, based on at least one of the received tags; and
forwarding a sub-portion of the video feed portion stored on the memory for further processing, the forwarded sub-portion having a video length predefined for the event type of the determined occurrence.

24. The method of claim 23, wherein said storing comprises maintaining at least one buffer storing a most recent portion of the video feed being received, on the memory of the server computer, and said forwarding comprises forwarding the sub-portion of the video feed portion stored in the buffer for said further processing.

25. The method of claim 23, wherein said forwarding comprises communicating the sub-portion to a computer remote from the server computer.

26. The method of claim 23, further comprising receiving a time indication in at least one of the tags, wherein said determining is further based on the received time indication.

27. The method of claim 26, further comprising finding a correlation between a time indication received in a first one of the tags and a time indication received in a second one of the tags, wherein said determining is further based on the found correlation.

28. The method of claim 23, wherein said determining is further based on a time of receipt of at least one of the tags.

29. The method of claim 28, further comprising finding a correlation between a time of receipt of a first one of the tags and a time of receipt of a second one of the tags, wherein said determining is further based on the found correlation.

30. The method of claim 23, further comprising receiving a location indication in at least one of the tags, wherein said determining is further based on the received location indication.

31. The method of claim 30, further comprising finding a correlation between a location indication received in a first one of the tags and a location indication received in a second one of the tags, wherein said determining is further based on the found correlation.

32. The method of claim 23, further comprising receiving an event type indication in at least one of the tags, wherein said determining is further based on the received event type indication.

33. The method of claim 32, further comprising finding a correlation between an event type indication received in a first one of the tags and an event type indication received in a second one of the tags, wherein said determining is further based on the found correlation.

34. The method of claim 23, further comprising generating a video clip based at least on the forwarded sub-portion.

35. The method of claim 34, further comprising selecting at least one recipient according to at least one of the received tags, and provisioning the generated video clip to the selected recipient.

36. The method of claim 23, further comprising receiving a respective video clip with at least one of the tags, and combining the received video clip and the forwarded sub-portion into a compound video clip.

37. The method of claim 23, further comprising receiving at least two video clips, each one of the video clips being received with a respective one of the tags, and combining at least two of the received video clips with the forwarded sub-portion into a compound video clip.

38. The method of claim 23, further comprising a preliminary step of providing a GUI (Graphical User Interface) to at least one of the client devices, the GUI comprising one or more graphical elements, each element being associated with a respective event type, the GUI being operable by a user of the client device, for generating and forwarding a tag to the server computer upon actuation of one of the elements.

39. The method of claim 38, wherein said providing of the GUI is carried out using a website accessible by the client device.

40. The method of claim 38, wherein said providing of the GUI comprises providing a client application to the client device.

41. A non-transitory computer readable medium storing computer executable instructions for performing steps of crowd-sourced video generation, the steps comprising:
by a server computer in communication with a plurality of remote client devices, receiving a feed of video captured by a camera;
on a memory of the server computer, storing at least a portion of the video feed being received;
receiving at least one tag from a respective one of the client devices;
determining an occurrence of an event type, based on an at least one of the received tags; and
forwarding a sub-portion of the video feed portion stored on the memory for further processing, the forwarded sub-portion having a video length predefined for the event type of the determined occurrence.

42. The computer readable medium of claim 41, wherein said storing comprises maintaining at least one buffer storing a most recent portion of the video feed being received, on the memory of the server computer, and said forwarding comprises forwarding the sub-portion of the video feed portion stored in the buffer for said further processing.

43. An apparatus for crowd-sourced video generation, implemented on at least one server computer in communication with a plurality of remote client devices, and comprising:
a video feed receiver, configured to receive a feed of video captured by a camera;
a memory maintainer, in communication with said video feed receiver, configured to store at least a portion of the video feed being received, on a memory of the server computer;
a tag receiver, configured to receive at least one tag from a respective one of the client devices;
an occurrence determiner, in communication with said tag receiver, configured to determine an occurrence of an event type, based on an at least one of the received tags; and
a forwarder, in communication with said occurrence determiner and said memory maintainer, configured to forwarding a sub-portion of the video feed portion stored in the memory for further processing, the forwarded sub-portion having a video length predefined for the event type of the determined occurrence.

44. The apparatus of claim 43, wherein said memory maintainer is configured to store the portion by maintaining at least one buffer storing a most recent portion of the video feed being received on the memory of the server computer, and said forwarder is configured to forward the sub-portion by forwarding the sub-portion of the video feed portion stored in the buffer for said further processing.
